(19) United States
(12) Patent Application Publication
(10) Pub. No.: US 2017/0148110 A1
(43) Pub. Date: May 25, 2017

(54) SYSTEM, METHOD AND PROGRAM PRODUCT FOR MANAGING OPEN-PIT MINING

(71) Applicant: International Business Machines Corporation, Armonk, NY (US)

(72) Inventors: Bruno Da Costa Flach, RIO DE JANEIRO (BR); Takashi Imamichi, RIO DE JANEIRO (BR); Igor C. Oliveira, RIO DE JANEIRO (BR)

(73) Assignee: International Business Machines Corporation, Armonk, NY (US)

(21) Appl. No.: 14/948,446

(22) Filed: Nov. 23, 2015

(51) Int. Cl. G06Q 50/02; G01W 1/14; G01W 1/10; G06N 5/04; G06Q 10/06

(52) U.S. Cl. CPC G06Q 50/02; G06N 5/04; G06Q 10/06315; G06Q 10/067; G01W 1/10; G01W 1/14

(57) ABSTRACT

An open-pit mining system, method of forecasting weather and a computer program product therefor. A dispatching system models local pit conditions and generates a dispatching plan for mining equipment for each mining shift. A forecasting system generates local forecasts. Individual pieces of mining equipment include wiper frequency sensors sensing wiper use whenever equipment wipers are engaged. The wiper frequency sensors forward wiper use data to the forecasting system, which determines pit rainfall from collected sensed wiper frequency. The dispatching system adjusts the dispatching plan to compensate for rainfall effects.

### BACKGROUND OF THE INVENTION

Field of the Invention

The present invention is related to open-pit mining, and more particularly, to managing open-pit mining during periods of rainfall.

Background Description

Open-pit or open-cast mining is a surface mining technique for extracting ore deposits of commercially useful minerals from a very large open pit or borrow pit. Modern open-pit mining operations rely heavily on large, heavy equipment including, for example, bull dozers, excavators, back hoes and dump trucks. These behemoths remove an overburden of surface material from a large field to leave an earthen floor at the vein with the valuable subsurface deposit. The typical pit may cover an area of square miles with that same heavy equipment being used to remove the exposed ore from the vein, and carry loads of ore over unpaved pit roads to extract the valuable minerals.

Operators can mine at full capacity with a firm floor in a dry pit. However, when a typical pit gets wet, the unpaved pit roads get very muddy. During heavy rain, heavy equipment can bog down in the mud, even halting mining completely. To continue mining in rainfall, trucks may need to change to alternate, predefined routes. Even so, equipment may still get stuck. Extracting one of these behemoths from the mud can occupy one or more bulldozers and excavators, taking them away from more productive mining activity. Consequently, rainfall can have a major impact on open-pit mining operations.

Thus, there is a need for efficiently, locally forecasting weather; and, more particularly for efficiently, locally forecasting rainfall in real time for open-pit mining operations to avoid potentially dangerous and unproductive situations.

### SUMMARY OF THE INVENTION

A feature of the invention is dispatching plans are adjusted for mining equipment based on rainfall sensed by the mining equipment;

Another feature of the invention is rainfall in open-pit mines is detected from mining equipment wiper use;

Yet another feature of the invention is rainfall in open-pit mines is detected from mining equipment wiper use, and dispatching plans are adjusted for mining equipment based on rainfall sensed by the mining equipment.

The present invention relates to an open-pit mining system, method of forecasting weather and a computer program product therefor. A dispatching system models local pit conditions and generates a dispatching plan for mining equipment for each mining shift. A forecasting system generates local forecasts. Pieces of mining equipment include wiper frequency sensors sensing wiper use whenever equipment wipers are engaged. The wiper frequency sensors forward wiper use data to the forecasting system, which determines pit rainfall from collected sensed wiper frequency. The dispatching system adjusts the dispatching plan to compensate for rainfall effects.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 shows an example of an open-pit mine management system, forecasting weather hazards and managing mining activity, according to a preferred embodiment of the present invention;

FIG. 2 shows a flowchart example of managing open mining by a preferred system.

### DESCRIPTION OF PREFERRED EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

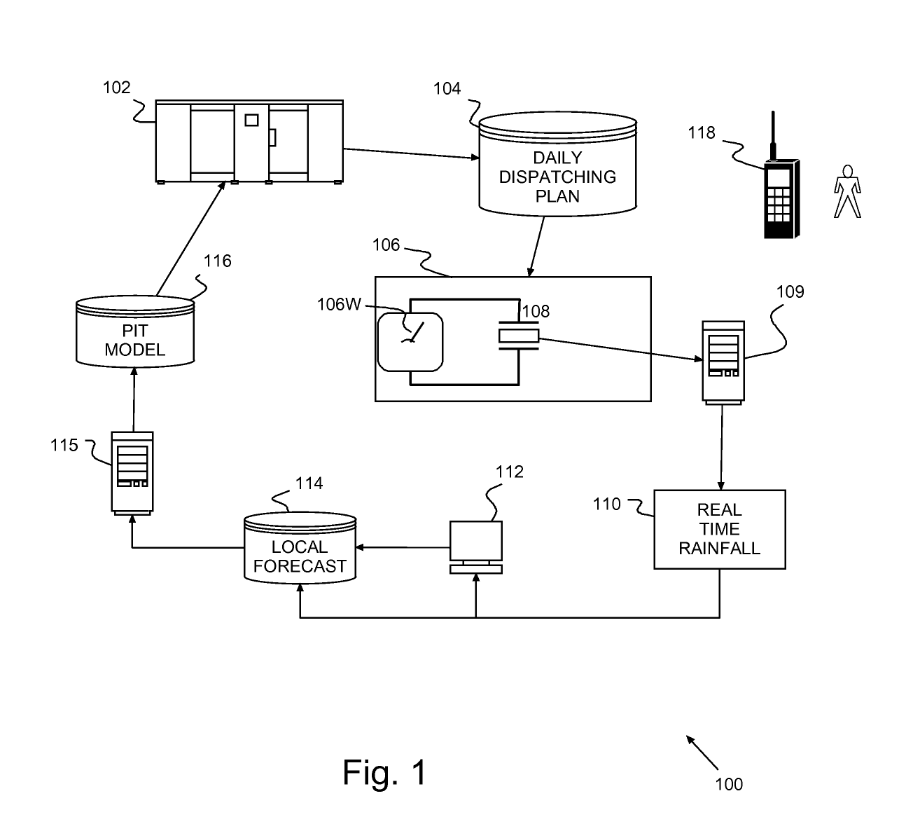

Turning now to the drawings and more particularly, FIG. 1 shows an example of an open-pit mine management system 100, forecasting weather hazards and managing mining activity, according to a preferred embodiment of the present invention. In particular, a preferred system 100 uses local windshield wiper frequency as determined by on board equipment sensors, preferably in stock equipment, to determine pit rainfall and accumulation to adjust mining operations for minimizing slowdown and optimum recovery.

A dispatching system 102 generates a dispatching plan 104 for mining equipment 106 for each next shift. Mining equipment 106 include built-in sensors 108 that normally monitor and control systems on equipment 106, including, equipment wiper 106W use. A rainfall measurement system 109 collects rainfall data 110 from sensors 108 at equipment 106. A forecasting system 112 generates high resolution local forecasts 114 for the whole pit, and assimilates pit rainfall 110 to adjust the forecast 114 as necessary. A pit modelling system 115 models 116 the pit under local conditions based on the forecast 114, as adjusted. The dispatching system 102 refines the dispatching plan 104, based on the modeled pit conditions 116, and distributes the plan 104 to the mining equipment 106, e.g., on a suitable mobile device 118.

It should be noted that although shown and described herein in independent computers, the preferred dispatching system 102, rainfall measurement system 109, forecasting system 112 and pit modelling system 115 may be collocated on the same computer or personal computer (PC) or further distributed among several computers. Similarly, the dispatching plan 104 and local pit model 116 may be located and maintained on separate storage 104, 116, or collocated on the same storage.

Modern equipment typically include on board controllers that control and monitor nearly every on-going operation in/by the particular piece of equipment. During periods of rainfall, when operators engage equipment wipers, controller sensors 108 monitor windshield wiper use and frequency. The sensors 108 forward wiper frequency data for individual dispatched equipment to the rainfall measurement system 109, which determines pit rainfall 110 from the data in real time. Preferably, the forecasting system 112 uses a numerical or data-driven weather model to determine pit rainfall, as well as other meteorological conditions that may affect mining productivity. The dispatching system 102 forwards the refined plan 104 to the equipment 106 operators, e.g., on suitable mobile devices 118, such as cell phones and/or networked tablets, or on a computer monitor, such as forecasting system 112.

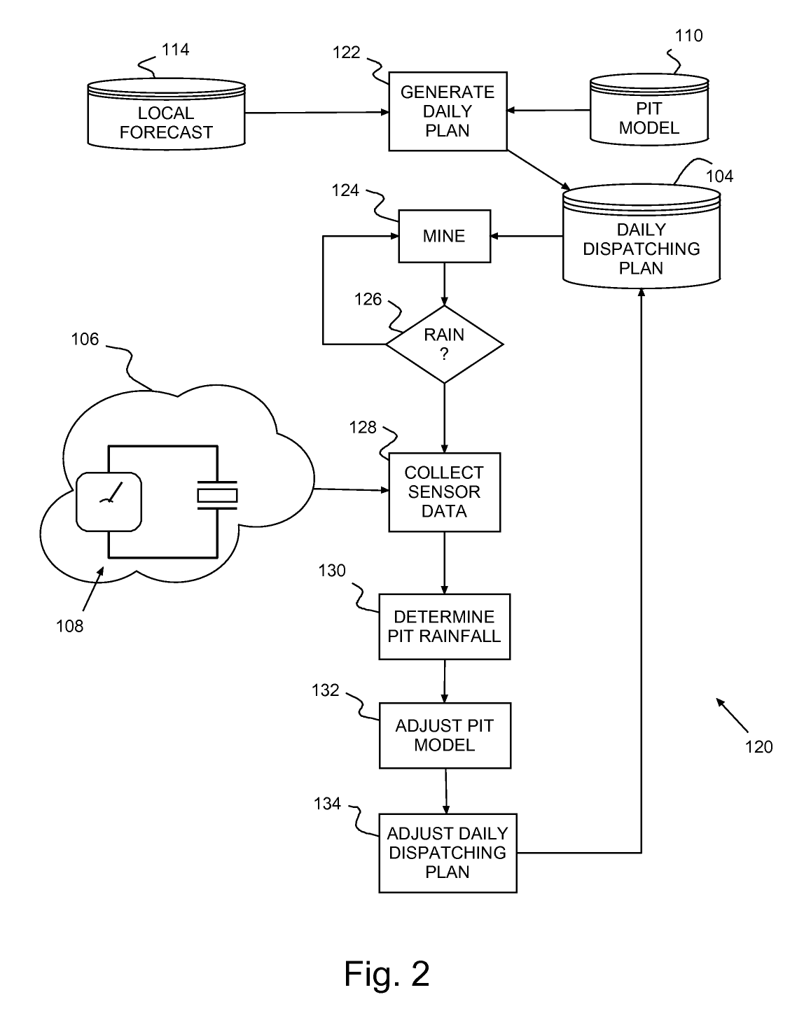

FIG. 2 shows a flowchart 120 example of managing open mining by a preferred system 100 of FIG. 1 with like features labeled identically. Initially, using the pit modeled 116 the dispatching system 102 generates 122 a dispatching plan 104. The shift begins mining 124 normally, based on the dispatching plan 104, and continues until it begins to rain 126. Mining equipment 106 sensors 108 sense 128 wiper frequency. The rainfall measurement system 109 determines rainfall 130 in real time from sensed wiper frequencies. The pit modelling system 115 adjusts 132 the pit model 116 for determined rainfall 130. Thus, the dispatching system 102 adjusts 134 the dispatching plan 104 and mining continues based on the adjusted plan.

So prior to the start of the next shift, using the pit model 116 the dispatching system 102 generates 122 a dispatching plan 104, automatically or interactively, for available mining equipment. The dispatching system 102 uses the current local forecast 114 in further combination with equipment parameters and operational data, e.g., load capacity, speed and vertical acceleration. The shift begins mining 124 normally, based on the dispatching plan 104, and continues until it begins to rain 126. When it starts to rain 126, equipment operators switch on wipers, adjusting pulse delays or switching the wipers full on depending on rain intensity. Mining equipment 106 sensors 108, preferably, are located with each individual piece of mining equipment 106 for sensing 128 wiper frequency.

The individual sensed frequencies tend to map rain intensity across the entire pit, and from this, the forecasting system 112 can determine/measure rainfall 130 in real time. Preferably, the forecasting system 112 aggregates rain measurements from sensed wiper frequencies from all of the dispatched equipment, to forecast overall pit rainfall. For example, Rabiei et al., “Rainfall estimation using moving cars as rain gauges—laboratory experiments,” Hydrol. Earth Syst. Sci., 17, 4701-4712, doi:10.5194/hess-17-4701-2013, 2013, teaches correlating driver controlled wiper frequency and rainfall intensity.

Based on that real time rainfall forecast, the dispatching system 102 can adjust 132 the pit model 116. Then, the dispatching system 102 adjusts 134 the dispatching plan 104 based on the rainfall refined pit model 116 to leverage real time rainfall information. The adjusted dispatching plan 104 mitigates, and preferably, avoids potentially dangerous and unproductive situations, allowing operators continue mining well into inclement weather for maximized mine productivity.

Advantageously, a preferred mining management system provides for monitoring rainfall in open pit mining operations even in locales with no or very few dedicated or fixed rainfall sensors, by relying primarily on wiper sensors to measure rainfall. As operators use wipers, interpolating wiper frequencies from all mine assets provides an accurate, real-time rainfall estimate. Thus having a real-time rainfall estimate, road conditions may be modeled to accurately reflect pit road conditions in a high resolution short-term (nowcasting) model. The pit model couples the rainfall forecast to the dispatching system, which uses the model to adjust and refine the current dispatching plan. Thus, a preferred system enables real-time operational responses for improved efficiency, continuing mining operation, e.g., for trucks, excavator and other infrastructure, in spite of rainfall.

While the invention has been described in terms of preferred embodiments, those skilled in the art will recognize that the invention can be practiced with modification within the spirit and scope of the appended claims. It is intended that all such variations and modifications fall within the scope of the appended claims. Examples and drawings are, accordingly, to be regarded as illustrative rather than restrictive.

What is claimed is:

1. An open-pit mining management system comprising:
a dispatching system modeling local pit conditions and generating dispatching plans for mining equipment;
a forecasting system generating local forecasts; and
a plurality of wiper frequency sensors, each of a plurality of pieces of said mining equipment including one of said plurality of wiper frequency sensors sensing wiper use whenever wipers are engaged on the respective mining equipment piece and forwarding wiper use data to said forecasting system, said forecasting system determining pit rainfall responsive to collective sensed wiper frequency.

2. An open-pit mining management system as in claim 1, wherein said dispatching system applies a current forecast to a pit model to generate said dispatching plans for each mining shift.

3. An open-pit mining management system as in claim 2, wherein said dispatching system further generates said dispatching plans from equipment parameters and operational data for said mining equipment.

4. An open-pit mining management system as in claim 3, wherein said equipment parameters include load capacity, speed and vertical acceleration.

5. An open-pit mining management system as in claim 1, said forecasting system using a numerical weather model to generate high resolution local forecasts.

6. An open-pit mining management system as in claim 1, said forecasting system using a data-driven weather model to generate high resolution local forecasts.

7. An open-pit mining management system as in claim 1, wherein said forecasting system forwards a revised local forecast responsive to determined said pit rainfall to said dispatching system, said dispatching system adjusting the current dispatching plan responsive to said revised local forecast.

8. An open-pit mining management system as in claim 7, wherein said dispatching system applies said revised local forecast to a pit model to adjust said current dispatching plan.

9. An open-pit mining management system as in claim 7, further comprising one or more mobile devices, each mobile device being associated with a respective mining equipment piece, said revised local forecast being forwarded to the respective mobile devices.

10. A method of managing open-pit mining, said method comprising:
generating a dispatching plan for mining equipment in an open-pit mine;
dispatching said mining equipment to begin the next mining shift, said mining equipment mining according to said dispatching plan;
receiving from dispatched said mining equipment an indication of rain falling on said dispatched mining equipment;
determining the effects of indicated rainfall on the area being mined; and
adjusting said dispatching plan responsive to said indicated rainfall.

11. A method of managing open-pit mining as in claim 10, wherein receiving the rainfall indication comprises receiving a wiper frequency from one or more said dispatched mining equipment.

12. A method of managing open-pit mining as in claim 11, wherein generating said dispatching plans comprises:
providing a current weather forecast for the mining area for the next mining shift; and
applying said current forecast to a pit model, equipment parameters, and operational data for said mining equipment to determine pit conditions.

13. A method of managing open-pit mining as in claim 12, wherein determining indicated rainfall effects comprises:
determining rainfall from the wiper frequencies from all said dispatched mining equipment;
providing a revised weather forecast for the mining area, revised for rainfall; and
applying said revised forecast to said pit model to determine pit conditions during said indicated rainfall, said dispatching plan being adjusted responsive to determined said pit conditions.

14. A method of managing open-pit mining as in claim 13, wherein said equipment parameters include load capacity, speed and vertical acceleration.

15. A method of managing open-pit mining as in claim 13, wherein providing said revised weather forecast comprises numerically modeling weather to generate a high resolution local forecast.

16. A method of managing open-pit mining as in claim 12, wherein providing said revised weather forecast comprises modeling weather in a data-driven model to generate a high resolution local forecast.

17. A computer program product for managing open-pit mining, said computer program product comprising a computer usable medium having computer readable program code stored thereon, said computer readable program code comprising:
computer readable program code means for generating a dispatching plan for mining equipment in an open-pit mine for;
computer readable program code means for dispatching said mining equipment to begin the next mining shift, said mining equipment mining according to said dispatching plan;
computer readable program code means for receiving from dispatched said mining equipment an indication of rain falling on said dispatched mining equipment;
computer readable program code means for determining the effects of indicated rainfall on the area being mined; and
computer readable program code means for adjusting said dispatching plan responsive to said indicated rainfall.

18. A computer program product for managing open-pit mining as in claim 17, wherein said computer readable program code means for generating said dispatching plans comprises:
computer readable program code means for providing a current weather forecast for the mining area the next mining shift; and
computer readable program code means for applying said current forecast to a pit model, equipment parameters, and operational data for said mining equipment to determine pit conditions.

19. A computer program product for managing open-pit mining as in claim 18, wherein said computer readable program code means for receiving rainfall indication comprises computer readable program code means for receiving wiper frequency data from said dispatched mining equipment.

20. A computer program product for managing open-pit mining as in claim 19, wherein said computer readable program code means for determining indicated rainfall effects comprises:
computer readable program code means for determining rainfall from received said wiper frequency data;
computer readable program code means for providing a revised weather forecast for the mining area from determined said rainfall; and
computer readable program code means for applying said revised forecast to said pit model to determine pit conditions during said determined rainfall, said dispatching plan being adjusted responsive to determined said pit conditions.
